(19) United States
(12) Patent Application Publication
(10) Pub. No.: US 2026/0202823 A1
(43) Pub. Date: Jul. 16, 2026

(54) Multifaceted Thermal-Response Shaping

(71) Applicant: Google LLC, Mountain View, CA (US)

(72) Inventors: Mohsen Heidarinejad, San Jose, CA (US); Arpit Mittal, San Jose, CA (US)

(73) Assignee: Google LLC, Mountain View, CA (US)

(21) Appl. No.: 19/025,531

(22) Filed: Jan. 16, 2025

(51) Int. Cl. G05B 19/4155

(52) U.S. Cl. CPC G05B 19/4155; G05B 2219/49216

(57) ABSTRACT

Techniques and apparatuses are described for implementing multifaceted thermal-response shaping. In example aspects, a thermal control system manages heat that is generated by a subsystem of a system-on-chip to protect the subsystem from being damaged due to overheating, to maintain reliability of the system-on-chip, and to avoid creating a potentially unsafe situation for the user to operate a computing device with the system-on-chip. The thermal control system triggers the subsystem to operate at different operation points to shape a thermal response of the system-on-chip. The thermal control system appropriately shapes the thermal response based on an evaluation of two or more metrics, such as temperature and power, which can be associated with similar or different time scales. With this flexible, multifaceted approach, the thermal control system can determine an operation point that can improve the user experience and does not compromise a safety or reliability of the subsystem.

### BACKGROUND

An electronic device can be implemented with a system-on-chip (SoC), which can provide many features of the electronic device. An example system-on-chip can include multiple subsystems, such as a central processing unit (CPU), a graphics processing unit (GPU), and/or an image processing unit (IPU). As a user engages with the electronic device, operations of these subsystems can generate heat. Left unchecked, the accumulation of heat within the electronic device can result in a high temperature that can damage the system-on-chip, can damage other components of the electronic device, and/or can reduce a reliability of the electronic device. In some cases, the electronic device can become unsafe for the user to operate.

### SUMMARY

Techniques and apparatuses are described for implementing multifaceted thermal-response shaping. In example aspects, a system-on-chip includes at least one subsystem and at least one thermal control system. The thermal control system manages heat that is generated by the subsystem to protect the subsystem from being damaged due to overheating, to maintain reliability of the system-on-chip, and to avoid creating a potentially unsafe situation for the user to operate a computing device with the system-on-chip. More specifically, the thermal control system triggers the subsystem to operate at different operation points to shape a thermal response of the system-on-chip. The thermal control system appropriately shapes the thermal response based on an evaluation of two or more metrics, which are associated with different workload-dependent characteristics of the subsystem. The metrics can also be associated with different time scales, such as an instantaneous measurement and/or an averaged (or filtered) measurement. With this flexible, multifaceted approach, the thermal control system can determine an operation point that can improve the user experience and does not compromise a safety or reliability of the subsystem.

Aspects described below include a first method performed by a system-on-chip. The method includes operating, during a first time interval, a subsystem of the system-on-chip at a first operation point. The method also includes determining, during the first time interval, a second operation point based on a first feedback metric of multiple feedback metrics associated with the subsystem. The method additionally includes operating, during a second time interval, the subsystem of the system-on-chip at the second operation point. The method further includes determining a third operation point based on a second feedback metric of the multiple feedback metrics associated with the subsystem. The second feedback metric is different from the first feedback metric. The method also includes operating, during a third time interval, the subsystem of the system-on-chip at the third operation point.

Aspects described below include a second method performed by a system-on-chip. The method includes operating, during a first time interval, a subsystem of the system-on-chip at a first operation point. The method also includes determining, during the first time interval, a first candidate operation point based on a measured temperature of the subsystem. The method additionally includes determining, during the first time interval, a second candidate operation point based on a measured power metric of the subsystem. The method further includes selecting one of the first candidate operation point or the second candidate operation point as a second operation point. The method also includes operating, during a second time interval, the subsystem of the system-on-chip at the second operation point.

Aspects described below also include an apparatus including a system-on-chip with at least one subsystem and at least one thermal control system. The system-on-chip is configured to perform, using the at least one subsystem and at least one thermal control system, any of the described methods.

Aspects described below also include a system with means for performing multifaceted thermal-response shaping.

### BRIEF DESCRIPTION OF DRAWINGS

Apparatuses and techniques for implementing multifaceted thermal-response shaping are described with reference to the following drawings. The same numbers are used throughout the drawings to reference like features and components:

FIG. 1 illustrates an example environment in which multifaceted thermal-response shaping can be implemented;

FIG. 2 illustrates an example implementation of a computing device that can implement aspects of multifaceted thermal-response shaping;

FIG. 3 illustrates an example relationship between a subsystem and a thermal control system of a system-on-chip;

FIG. 4 illustrates example operation points of a subsystem;

FIG. 5 illustrates example components of a thermal control system for implementing multifaceted thermal-response shaping;

FIG. 6 illustrates an example operation of a thermal control system for implementing multifaceted thermal-response shaping;

FIG. 7 illustrates a first example method for performing multifaceted thermal-response shaping;

FIG. 8 illustrates a second example method for performing multifaceted thermal-response shaping; and

FIG. 9 illustrates an example computing system embodying, or in which techniques may be implemented that enable use of, multifaceted thermal-response shaping.

### DETAILED DESCRIPTION

An electronic device can be implemented with a system-on-chip (SoC), which can provide many features of the electronic device. An example system-on-chip can include multiple subsystems, such as a central processing unit (CPU), a graphics processing unit (GPU), and/or an image processing unit (IPU). As a user engages with the electronic device, operations of these subsystems can generate heat. Left unchecked, the accumulation of heat within the electronic device can result in a high temperature that can damage the system-on-chip, can damage other components of the electronic device, and/or can reduce a reliability of the electronic device. In some cases, the electronic device can become unsafe for the user to operate.

To address this, an electronic device can be implemented with an active cooling system, such as a fan. While operating, the active cooling system can directly reduce an internal temperature of the electronic device by dissipating the accumulated heat within the electronic device and/or transferring the heat to the external environment. To operate, the active cooling system consumes power, which drains power from a power source of the electronic device. Many active cooling systems also have a significant footprint, which requires additional space within the electronic device. As such, an active cooling system may be impractical for some electronic devices, particularly mobile electronic devices, that place a premium on a small form factor and low power consumption.

Instead of using an active cooling system, other electronic devices are implemented with a passive thermal control system that throttles operations of components to manage temperature within the computing device. In contrast to the active cooling system, the passive thermal control system does not consume a significant amount of power during operation and has a smaller footprint. Some passive thermal control systems throttle operations based on a static or fixed thermal control policy. For example, a static thermal control policy can cause the electronic device the throttle operations to keep an internal temperature below a predetermined temperature threshold. Although this may be sufficient for some simple situations or for less-complex electronic devices, a static thermal control policy is unable to account for variations in workload (or usage) of the electronic device. Consequently, the passive thermal control system can cause the electronic device to sacrifice performance in order to ensure the thermal control policy is met, which may result in an unsatisfactory user experience. Considering multiple thermal control policies for different workloads to improve the user experience, however, may not be feasible as it can be challenging to scale and maintain multiple thermal control policies. There is a general need to manage a thermal profile of an electronic device across different workloads while satisfying size constraints and power constraints of the electronic device.

To address this need, techniques are described for implementing multifaceted thermal-response shaping. In example aspects, a system-on-chip includes at least one subsystem and at least one thermal control system. The thermal control system manages heat that is generated by the subsystem to protect the subsystem from being damaged due to overheating, to maintain reliability of the system-on-chip, and to avoid creating a potentially unsafe situation for the user to operate a computing device with the system-on-chip. More specifically, the thermal control system triggers the subsystem to operate at different operation points to shape a thermal response of the system-on-chip. The thermal control system appropriately shapes the thermal response based on an evaluation of two or more metrics, which are associated with different workload-dependent characteristics of the subsystem. The metrics can also be associated with different time scales, such as an instantaneous measurement and/or an averaged (or filtered) measurement. With this flexible, multifaceted approach, the thermal control system can determine an operation point that can improve the user experience and does not compromise a safety or reliability of the subsystem.

### Operating Environment

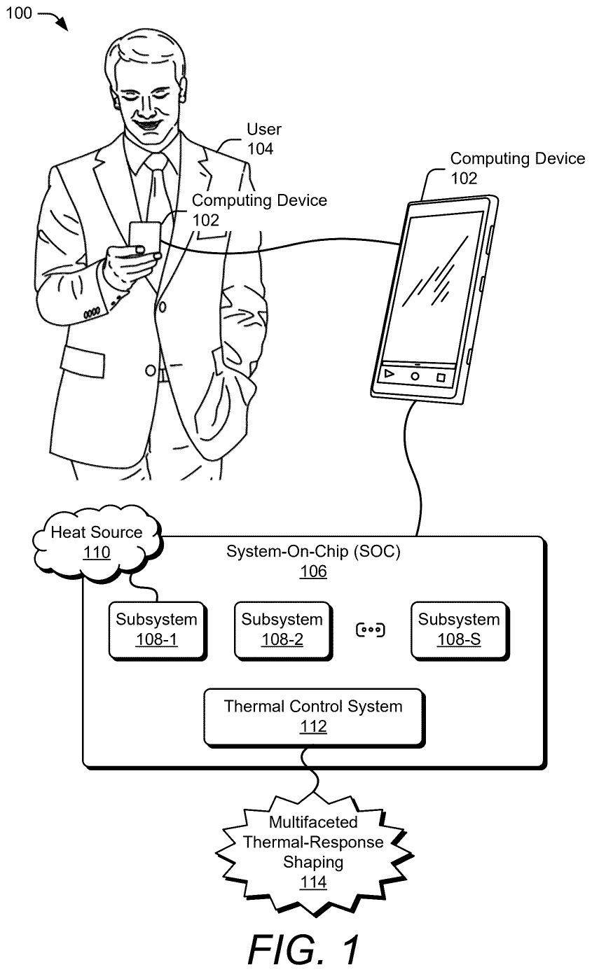

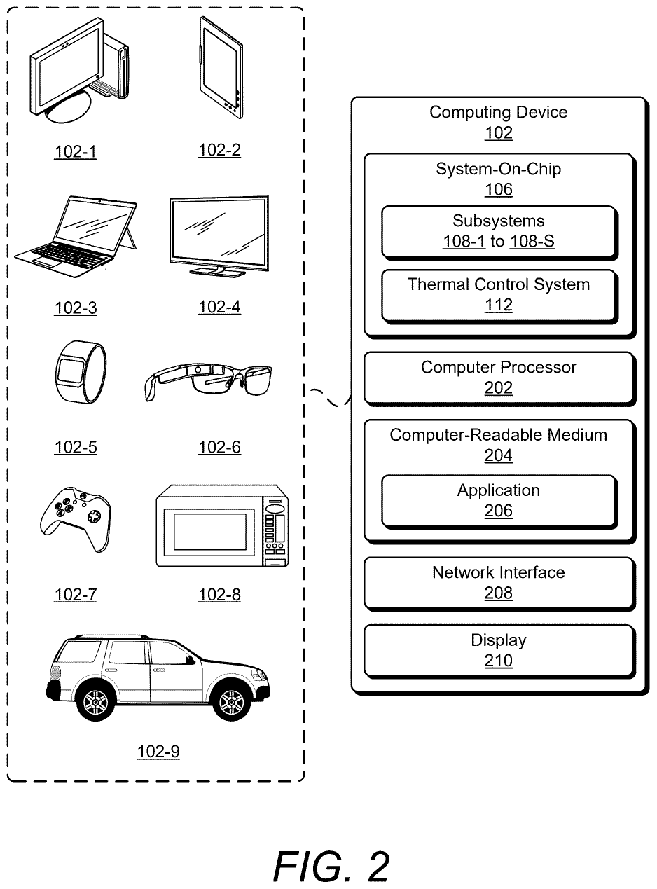

FIG. 1 is an illustration of an example environment 100 in which multifaceted thermal-response shaping can be implemented. In the example environment 100, a computing device 102 provides features and/or services for a user 104. Although depicted as a smartphone, the computing device 102 can include other types of devices, including those described with respect to FIG. 2. The computing device 102 includes at least one system-on-chip (SOC) 106. The system-on-chip 106 can be implemented with electronic circuitry, a microprocessor, memory, input-output (I/O) control logic, communication interfaces, firmware, and/or software useful to provide functionalities of the computing device 102.

The system-on-chip 106 includes multiple subsystems 108-1, 108-2 . . . 108-S, where S represents a positive integer. The subsystems 108 can also be referred to as agents, modules, intellectual-property blocks (IP blocks), or intellectual-property cores. Example subsystems 108 can include a central processing unit (CPU), a graphics processing unit (GPU), an image processing unit (IPU), a modem, a digital signal processor (DSP), a tensor processing unit (TPU), a neural processing unit (NPU), an image processing unit (IPU), a power processing unit (PPU), a display, a speaker, a processor, a memory, a sensor, an analog circuit, a digital circuit, components that handle application-specific processing functions, and so forth.

To facilitate independent operation, the subsystems 108 can have independent clock domains, independent voltage domains, independent power domains, or some combination thereof. Variations in the clock domains, the voltage domains, and the power domains can be based on the different functionalities provided by the subsystems 108 and/or can be based on different implementations of the subsystems 108. The clock domains enable the subsystems 108 to perform operations based on clock signals that are generated by different sources (e.g., generated by different clock generators or different phase-locked loops). The clock signals associated with different clock domains can have similar or different frequencies and/or phases. The different clock domains provide additional flexibility in designing the system-on-chip 106 and positioning the subsystems 108 within the system-on-chip 106. For instance, with the different clock domains, the subsystems 108 can be positioned relatively far apart compared to subsystems 108 that share a same clock domain.

The voltage domains enable the subsystems 108-1 and 108-2 to use different power supply voltages. The power domains enable the subsystems 108 to independently power on or off. With the different clock domains and the different voltage domains, the subsystems 108 can utilize dynamic voltage and frequency scaling (DVFS) to facilitate thermal control of the system-on-chip 106. With the different power domains, the subsystems 108 can also reduce heat generation by powering off when not in use.

One or more of the subsystems 108 represent a heat source 110. While operating, these subsystems 108 generate heat, which can contribute to increasing an internal temperature of the computing device 102. Left unchecked, the accumulation of heat within the computing device 102 can result in a high temperature that can damage the system-on-chip 106, can damage other components of the computing device 102, and/or can reduce a reliability of the computing device 102. In some cases, the high temperature can cause the computing device 102 to become unsafe for the user 104 to operate.

To avoid these situations, the system-on-chip 106 includes at least one thermal control system 112. From a high-level perspective, the thermal control system 112 manages a thermal influence of the system-on-chip 106 to the computing device 102's overall temperature. At a low-level perspective, the thermal control system 112 shapes a thermal response of the system-on-chip 106 by adjusting an operation point of one or more of the subsystems 108 to control an amount of heat that is generated by the system-on-chip 106. This shaping is performed based on an evaluation of two or more metrics that are associated with (or representative of) a workload of the subsystem 108. These metrics are monitored by the thermal control system 112. For additional flexibility, the thermal control system 112 can dynamically adjust a time scale associated with the monitoring and/or evaluation of these metrics.

A subsystem 108's, or more generally the system-on-chip 106's, thermal response can be visualized as a graph of temperature over time. The thermal-response shaping provided by the thermal control system 112 can set different thresholds associated with values of the temperature different rates of a change (e.g., a slope) of the temperature, and/or different envelopes associated with the temperature. With this shaping, the system-on-chip 106 can achieve a target level of performance under various workload conditions and/or for a given time period without exceeding limitations of the subsystem 108.

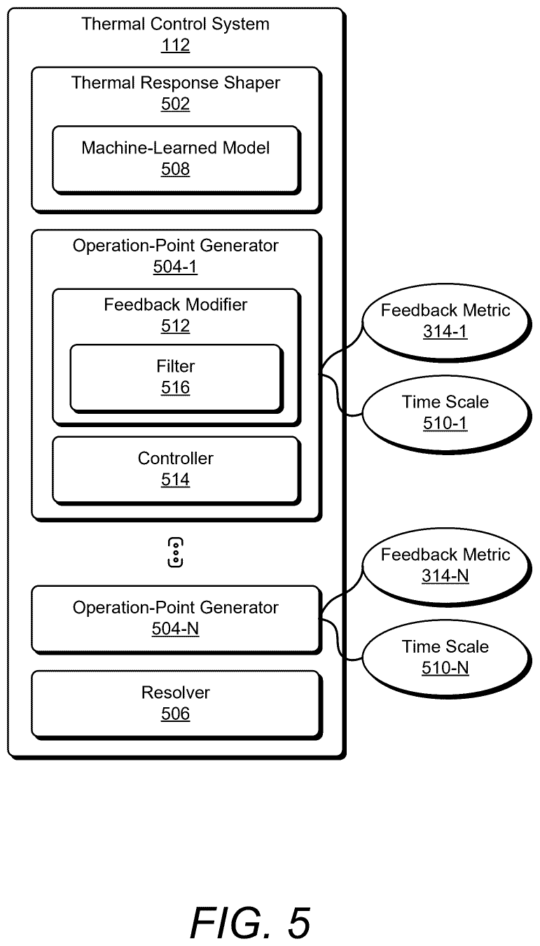

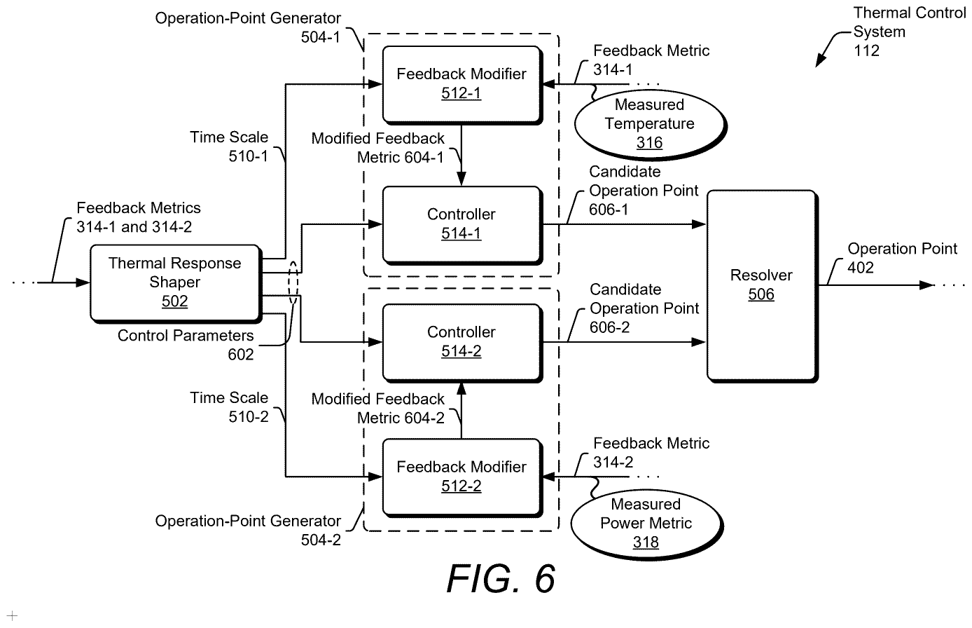

Over time, the thermal control system 112 can determine the operation point based on different metrics and/or based on different time scales. With this flexible, multifaceted approach, the thermal control system 112 can determine an operation point that can improve the user experience and does not compromise a safety or reliability of the subsystem 108. An example implementation of the thermal control system 112 is further described with respect to FIGS. 5 and 6.

The thermal control system 112 can be considered another subsystem 108 of the system-on-chip 106. In some implementations, a single thermal control system 112 provides multifaceted thermal-response shaping 114 for a single subsystem 108. In other implementations, a single thermal control system 112 provides multifaceted thermal-response shaping 114 for multiple subsystems 108. In still other implementations, multiple thermal control systems 112 provide multifaceted thermal-response shaping 114 for different sets of subsystems 108 within the system-on-chip 106. The components of the system-on-chip 106 (e.g., the subsystems 108 and the thermal control system 112) can alternatively be implemented within other types of integrated circuits or embedded systems, such as a microchip, an application-specific integrated circuit (ASIC), an application-specific standard product (ASSP), a digital signal processor (DSP), a programmable system-on-chip (PSoC), system-in-package (SiP), controller, and so forth. The computing device 102 is further described with respect to FIG. 2.

FIG. 2 illustrates an example computing device 102. The computing device 102 is illustrated with various non-limiting example devices, including a desktop computer 102-1, a tablet 102-2, a laptop 102-3, a television 102-4, a computing watch 102-5, computing glasses 102-6, a gaming system 102-7, a microwave 102-8, and a vehicle 102-9. Other devices may also be used, including a hearable, a home service device, a smart speaker, a smart thermostat, a baby monitor, a Wi-Fi™ router, a drone, a trackpad, a drawing pad, a netbook, an e-reader, a home automation and control system, a wall display, or another home appliance. Note that the computing device 102 can be wearable, non-wearable but mobile, or relatively immobile (e.g., desktops and appliances). The computing device 102 includes at least one system-on-chip 106. The system-on-chip 106 includes the subsystems 108-1 to 108-S and the thermal control system 112, as described in FIG. 1.

The computing device 102 also includes at least one computer processor 202 and at least one computer-readable medium 204 (e.g., non-transitory computer-readable medium). The computer-readable medium 204 can include memory media and/or non-transitory storage media. An operating system (not shown) embodied as computer-readable instructions on the computer-readable medium 204 can be executed by the computer processor 202.

The computer-readable medium 204 can include one or more applications 206. Execution of the application 206 can involve operating one or more subsystems 108. Example applications 206 can include a messaging application, an application that plays videos, a navigation application, or a gaming application. Different applications 206 can have different performance requirements and cause the subsystems 108 to operate with different workloads. For example, some applications 206 can utilize the first subsystem 108-1, other applications 206 can utilize the second subsystem 108-2, and still other applications 206 can utilize multiple subsystems 108 (e.g., the subsystems 108-1 and 108-2). In general, each application 206 can be associated with a particular thermal usage characteristic, which represents an amount of heat generated by the system-on-chip 106. This heat generation impacts an overall temperature of the computing device 102.

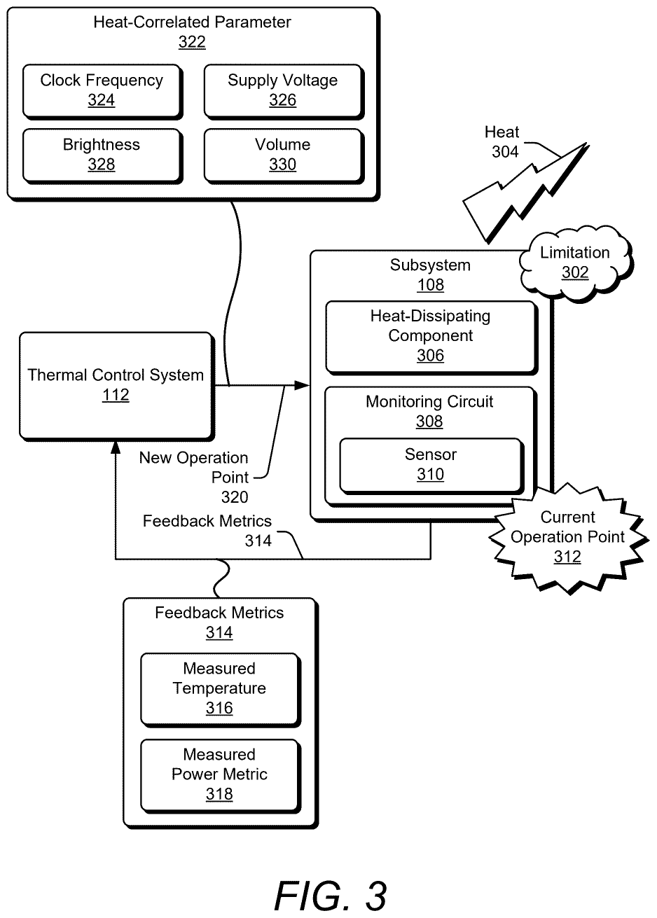

The computing device 102 can additionally include a network interface 208 for communicating data over wired, wireless, or optical networks. For example, the network interface 208 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, Bluetooth™, and the like. The computing device 102 may also include a display 210. An example relationship between the thermal control system 112 and one of the subsystems 108 is further described with respect to FIG. 3.

### Multifaceted Thermal-Response Shaping

FIG. 3. illustrates an example relationship between the subsystem 108 and the thermal control system 112, which are communicatively coupled together. Although a single subsystem 108 is depicted in FIG. 3, it is to be understood that the thermal control system 112 can be coupled to more than one subsystem 108. Some subsystems 108 can have an operation limitation 302. The limitation 302 can represent an operating parameter that is not to be exceeded to avoid compromising an operation of the subsystem 108, a reliability of the subsystem 108, and/or user safety. In many cases, meeting or surpassing the limitation 302 can damage the subsystem 108 and/or decrease a reliability of the subsystem 108. Some limitations 302, such as a safety-based limitation, can represent a maximum instantaneous temperature limit. Keeping an instantaneous temperature measurement of the subsystem 108 below the maximum instantaneous temperature limit can protect the subsystem 108 from damage caused by operating at a high temperature. Other limitations 302, such as a reliability-based limitation, can represent a maximum average temperature limit. Keeping an average temperature measurement of the subsystem 108 below the maximum average temperature limit can preserve a reliability of the subsystem 108 (e.g., can avoid degrading or compromising the reliability of the subsystem 108).

The subsystem 108 is an active component and a heat source 110, which means that the subsystem 108 consumes power and generates heat 304 during operation. The subsystem 108 includes at least one heat-dissipating component 306 and at least one monitoring circuit 308. While active (e.g., while consuming power), the heat-dissipating component 306 generates heat 304, which can contribute to the computing device 102's overall internal temperature. Example heat-dissipating components 306 can include an integrated circuit, a transistor, a resistor, a processor, and so forth.

The monitoring circuit 308 provides information regarding an operation of the subsystem 108 (e.g., an operation of the heat-dissipating component 306) to the thermal control system 112. In some implementations, the monitoring circuit 308 includes at least one sensor 310, which measures a temperature associated with the subsystem 108. The sensor 310 can be positioned on or proximate to the heat-dissipating component 306. In some cases, the monitoring circuit 308 includes multiple temperature sensors 310 to measure the temperature associated with the heat-dissipating component 306. The monitoring circuit 308 can measure or determine other operating parameters of the heat-dissipating component 306 (or more generally of the subsystem 108). For example, in some implementations, the monitoring circuit 308 can measure an amount of power that is consumed by the heat-dissipating component 306.

During operation, the subsystem 108 operates at a current operation point 312. The current operation point 312 represents a current configuration of the subsystem 108. In example implementations, the current operation point 312 can specify one or more heat-correlated parameters of the subsystem 108, examples of which are further described below.

To enable the thermal control system 112 to dynamically control an operation point of the subsystem 108 and manage the generation of heat 304, the monitoring circuit 308 generates at least two feedback metrics 314 based on an operation of the subsystem 108 at the current operation point 312. The subsystem 108 passes the feedback metrics 314 to the thermal control system 112.

Each feedback metric 314 characterizes a current workload of the subsystem 108. There can be a direct or indirect relationship between the feedback metric 314 and the workload of the subsystem 108. For example, one of the feedback metrics 314 can include a measured temperature 316 associated with the subsystem 108. The measured temperature 316 has a direct relationship with the workload of the subsystem 108. Increasing the workload can increase the measured temperature 316, for instance. The measured temperature 316 can represent an instantaneous measurement provided by the sensor 310. In the case of multiple sensors 310, the measured temperature 316 can represent an average or maximum of the instantaneous temperatures measured by the multiple sensors 310.

In some cases, the measured temperature 316 represents a limitation metric, which is used to evaluate a current operation of the subsystem 108 with respect to the limitation 302. The limitation metric can provide an indication to the thermal control system 112 of how close an operation of the subsystem 108 is approaching the limitation 302. With this information, the thermal control system 112 can take appropriate action to prevent the subsystem 108 from reaching or exceeding the limitation 302.

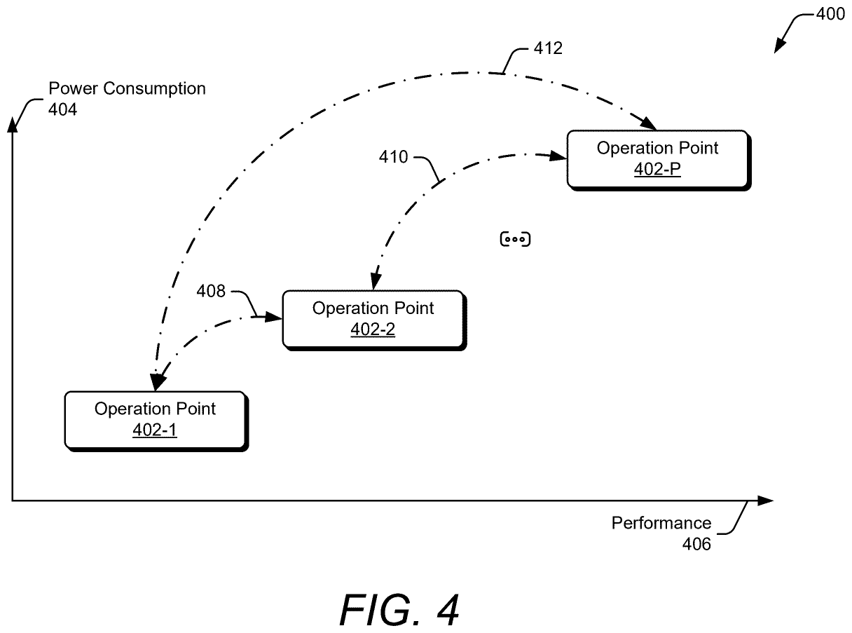

Another example feedback metric 314 can include a measured power metric 318 associated with the subsystem 108. The measured power metric 318 indicates an amount of power that is consumed by the subsystem 108. There is a direct relationship between the workload of the subsystem 108 and the measured power metric 318. Increasing the workload can increase the measured power metric 318, for instance. In some cases, the measured power metric 318 can represent an instantaneous measurement provided by the monitoring circuit 308. The power metric 318 provides an indication of the level of performance that is being provided to the user 104, as further described with respect to FIG. 4.

The thermal control system 112 generates a new operation point 320 based on evaluations of the feedback metrics 314, as further described with respect to FIG. 6. The new operation point 320 specifies at least one heat-correlated parameter 322 (e.g., a heat-correlated operation parameter 322) of the subsystem 108. Example heat-correlated parameters 322 include a clock frequency 324 and a supply voltage 326. If the subsystem 108 represents or includes the display 210, the heat-correlated parameter 322 can include a brightness 328 of the display 210. In the case that the subsystem 108 includes a speaker, a heat-correlated parameter 322 can include a volume 330. Other heat-correlated parameters 322 can include a transmit power associated with a transmitter. In many cases, a heat-correlated parameter 322 has a direct relationship with the heat 304 that is generated by an operation of the subsystem 108. For example, increasing any one of the clock frequency 324, the supply voltage 326, the brightness 328, or the volume 330 can increase an amount of heat 304 that is generated by the subsystem 108. By controlling the operation point of the subsystem 108, the thermal control system 112 can provide shape a thermal response of the system-on-chip 106. Different operation points can be associated with different levels of power consumption and different levels of performance, as further described with respect to FIG. 4.

FIG. 4 illustrates example operation points 402 of the subsystem 108. In this example, the subsystem 108 can operate at any one of the operation points 402-1, 402-2 . . . 402-P, where P represents a positive integer. A graph 400 depicts an example relationship between the operation points 402 in terms of power consumption 404 and performance 406. Higher levels of performance 406 can enhance the user experience while lower levels of performance 406 can degrade the user experience.

In general, there is a direct relationship between power consumption 404 and performance 406. Operation points 402 associated with higher levels of power consumption 404 are also associated with higher levels of performance 406. Operation points 402 associated with lower levels of power consumption 404 are also associated with lower levels of performance 406. There is also a direct relationship between power consumption 404 and heat generation. Operation points 402 associated with higher levels of power consumption 404 are also associated with higher levels of heat generation. In contrast, operation points 402 associated with lower levels of power consumption 404 are associated with lower levels of heat generation.

The first operation point 402-1 consumes a first amount of power and provides a first level of performance 406. The operation point 402-2 consumes a second amount of power and provides a second level of performance 406. The second amount of power is greater than the first amount of power. Also, the second level of performance 406 is higher than the first level of performance 406. The operation point 402-P consumes a third amount of power and provides a third level of performance 406. The third amount of power is greater than the second amount of power. Also, the third level of performance 406 is higher than the second level of performance 406.

By dynamically changing the operation point 402 of the subsystem 108, the thermal control system 112 can adapt to various workloads and usage of the subsystem 108 while ensuring safety and/or reliability of the system-on-chip 106. In various situations, the thermal control system 112 can adjust the operation point 402 of the subsystem 108 in a slow, gradual manner or a fast, sudden manner. Consider a case in which the subsystem 108 can selectively operate at one of the three operation points 402-1, 402-2, and 402-P. In a first example situation, the thermal control system 112 gradually changes the operation point 402 of the subsystem 108, such as by causing the subsystem 108 to transition between the operation points 402-1 and 402-2 as indicated at 408, or by causing the subsystem 108 to transition between the operation points 402-2 and 402-P as indicated at 410. In these examples, the change in the operation point 402 causes a relatively small change in the power consumption 404 and the performance 406 of the subsystem 108. This gradual change in the operation point 402 can allow for a better user experience as the user 104 may not notice the incremental change in performance 406.

In a second example situation, the thermal control system 112 significantly changes the operation point 402 of the subsystem 108, such as by causing the subsystem 108 to transition between the operation points 402-1 and 402-P. In this example, the change in the operation point 402 causes a relatively large change in the power consumption 404 and the performance 406 of the subsystem 108. This type of situation can occur if an operation of the subsystem 108 is approaching the limitation 302 and the thermal control system 112 is to severely throttle an operation of the subsystem 108. As another example, this situation can occur if a predicted change in the usage of the subsystem 108 indicates that the thermal control system 112 can lift previous-enacted throttling restrictions to enhance the user experience. Example components of the thermal control system 112 are further described with respect to FIG. 5.

FIG. 5 illustrates example components of the thermal control system 112. In the depicted configuration, the thermal control system 112 includes at least one thermal response shaper 502, multiple operation-point generators 504-1 to 504-N, where N represents a positive integer, and at least one resolver 506. The thermal response shaper 502 determines thermal mitigation controls based on feedback metrics 314 provided by the subsystem 108. In more detail, the thermal response shaper 502 controls threshold generation and timing parameters for multifaceted thermal-response shaping 114.

In an example implementation, the thermal response shaper 502 can be implemented using a machine-learned model 508. The machine-learned model 508 can be trained, using supervised and/or unsupervised learning, to set the thresholds and timing parameters that optimize user experience (e.g., performance 406) while ensuring operation of the subsystem 108 is within one or more limitations 302. By setting the thresholds and timing parameters, the thermal response shaper 502 can appropriately shape the thermal response of the subsystem 108, or more generally the thermal response of the system-on-chip 106, in a manner that achieves some level of performance for the user 104 across various workload conditions and/or for a given time period.

In some implementations, the thermal response shaper 502 can take into account prior usage of the computing device 102 and/or a profile of a current user 104. The thermal response shaper 502 can be trained to maximize performance for the user 104 for situations in which the thermal response shaper 502 predicts that the user 104 is likely to be using the computing device 102 for a relatively short time period. The thermal response shaper 502 can also be trained to extend performance (e.g., reduce heat) for situations in which the thermal response shaper 502 predicts that the user 104 is likely to be using the computing device 102 for a relatively long time period.

The operation-point generators 504-1 to 504-N generate recommended operation points based on different feedback metrics 314 and/or based on different time scales, as further described with respect to FIG. 6. For example, the operation-point generator 504-1 generates a first recommended operation point based on a first feedback metric 314-1 and based on a first time scale 510-1. The operation-point generator 504-N generates a recommended operation point based on feedback metric 314-N and based on time scale 510-N. The time scales 510-1 and 510-N can have similar and/or different durations. In general, two operation-point generators 504 differ by being associated with different feedback metrics 314 and/or by being associated with different time scales 510. Operations of the operation-point generators 504 can occur in parallel and in an unsynchronized or independent manner. As such, the operation-point generators 504 can generate recommendations at different time intervals.

Each operation-point generator 504 includes at least one feedback modifier 512 and at least one controller 514. The feedback modifier 512 applies the appropriate time scale 510 to the feedback metric 314. In example implementations, the feedback modifier 512 is implemented using a filter 516, which calculates an average or filtered version of the feedback metric 314 over the time scale 510. The filter 516 can be a digital filter, such as an infinite-impulse response (IIR) filter. The controller 514 determines the recommended operation point based on information provided by the feedback modifier 512 and based on controls determined by the thermal response shaper 502.

The resolver 506 resolves conflicts amongst the operation-point generators 504-1 to 504-N and selects one of the recommendations determined by the operation-point generators 504-1 to 504-N. The resolver 506 can be designed with a conservative profile that selects one of the recommended operation points that is considered to be the most restrictive (e.g., is associated with the least amount of power consumption and/or heat generation). In other cases, the resolver 506 can have a performance-focused profile that selects one of the recommended thermal control policies that optimizes performance 406 while ensuring operation of the subsystem 108 stays within specified limitations 302. In various examples, the resolver 506 can be implemented using at least one comparator or at least one machine-learned model. An example relationship between the thermal response shaper 502, the operation-point generators 504, and the resolver 506 are further described with respect to FIG. 6.

FIG. 6 illustrates an example operation of the thermal control system 112. In the depicted configuration, the thermal control system 112 includes two operation-point generators 504-1 and 504-2. Although two operation-point generators 504 are explicitly shown in FIG. 6, it is to be understood that the techniques for multifaceted thermal-response shaping 114 can be applied to other implementations that include more than two operation-point generators 504. Outputs of the thermal response shaper 502 are coupled to the operation-point generators 504-1 and 504-2. Outputs of the controllers 514-1 and 514-2 are coupled to inputs of the resolver 506. The feedback modifiers 512-1 and 512-2 are coupled between the thermal response shaper 502 and the controllers 514-1 and 514-2, respectively.

During operation, the thermal response shaper 502 receives the feedback metrics 314 associated with the operation-point generators 504. For example, the thermal response shaper 502 receives the feedback metrics 314-1 and 314-2 associated with the operation-point generators 504-1 and 504-2. In an example situation, the feedback metric 314-1 represents a measured temperature 316 and the feedback metric 314-2 represents a measured power metric 318.

The thermal response shaper 502 generates control parameters 602 and time scales 510-1 and 510-2 based on the feedback metrics 314-1 and 314-2. The control parameters 602 provide guidance to the controllers 514-1 and 514-2 for determining the recommended operation point. Example control parameters 602 can include thresholds, cadences (e.g., timing metrics or frequencies), triggers, or some combination thereof. Each threshold can indicate an upper limit associated with a corresponding feedback metric 314. The cadence can control a timing of the controller 514, such as how often the controller 514 generates a recommendation for the resolver 506. The trigger controls whether the controller 514 is enabled or disabled. The time scales 510-1 and 510-2 specify timing windows that are used by the feedback modifiers 512-1 and 512-2 for processing the feedback metrics 314-1 and 314-2, respectively.

Generally speaking, control parameters 602 associated with a particular feedback metric 314 are determined based at least on an evaluation of that feedback metric 314. In some implementations, it is possible that control parameters 602 associated with a particular feedback metric 314 are determined based on evaluations of two or more feedback metrics 314. The thermal response shaper 502 passes control parameters 602 to the operation-point generator 504 corresponding to the feedback metric 314 associated with the control parameters 602. For example, the thermal response shaper 502 passes a set of control parameters 602 associated with the measured temperature 316 to the controller 514-1. The thermal response shaper 502 a set of control parameters 602 associated with the measured power metric 318 to the controller 514-2.

The feedback modifiers 512-1 and 512-2 respectively generate modified feedback metrics 604-1 and 604-2 based on the feedback metrics 314-1 and 314-2 and based on the time scales 510-1 and 510-2. The modified feedback metrics 604-1 and 604-2 can represent averaged versions of the feedback metrics 314-1 and 314-2, respectively. The controllers 514-1 and 514-2 generate candidate operation points 606-1 and 606-2 based on the control parameters 602 and based on the modified feedback metrics 604-1 and 604-2. The resolver 506 selects one of the candidate operation points 606-1 and 606-2, and passes the selected operation point 402 to the subsystem.

Over time, the resolver 506 can determine an operation point 402 that is based on different feedback metrics 314. At a first time interval, for instance, the resolver 506 can select the first candidate operation point 606-1, which is based on the measured temperature 316. At a second time interval, the resolver 506 can select the second candidate operation point 606-2, which is based on the measured power metric 318.

The resolver 506 can additionally or alternatively determine an operation point 402 that is based on different time scales 510. Consider a situation in which the first candidate operation point 606-1 is determined at the first time interval based on an instantaneous version of the measured temperature 316 and the second candidate operation point 606-1 is determined at the second time interval based on an instantaneous version of the measured power metric 318. At a third time interval, the resolver 506 can select the first candidate operation point 606-1, which is based on an averaged (or filtered) version of the measured temperature 316 over the time scale 510-1. At a fourth time interval, the resolver 506 can select the second candidate operation point 606-2, which is based on an averaged (or filtered) version of the measured power metric 318 over the time scale 510-2. Generally speaking, the techniques for implementing multifaceted thermal-response shaping 114 involve determining an operation point 402 of the subsystem 108 based on evaluations of two different feedback metrics 314 and/or based on evaluations over different time scales 510. With this flexible, multifaceted approach, the thermal control system 112 can determine an operation point 402 that can improve the user experience and does not compromise a safety or reliability of the subsystem 108.

### Example Methods

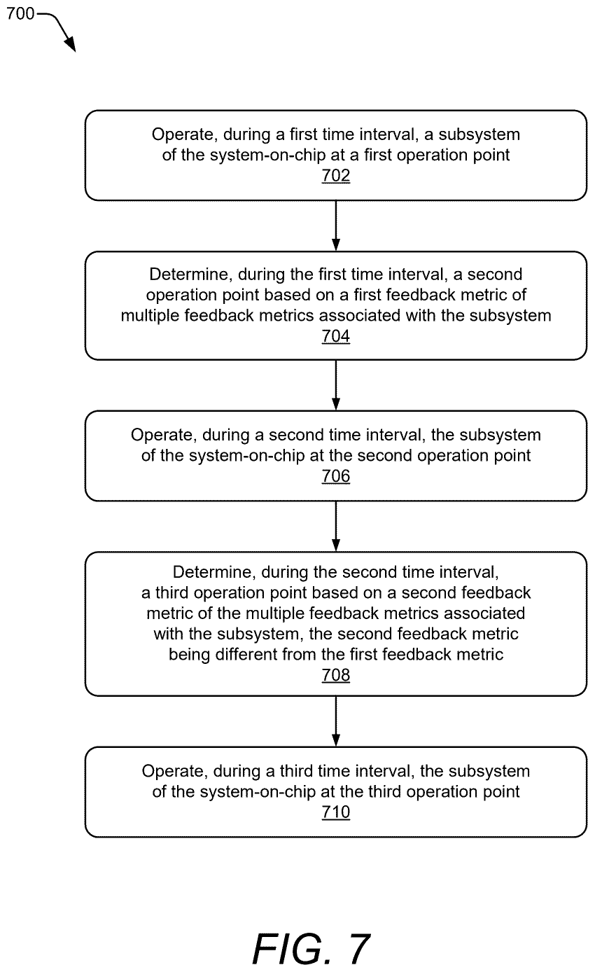

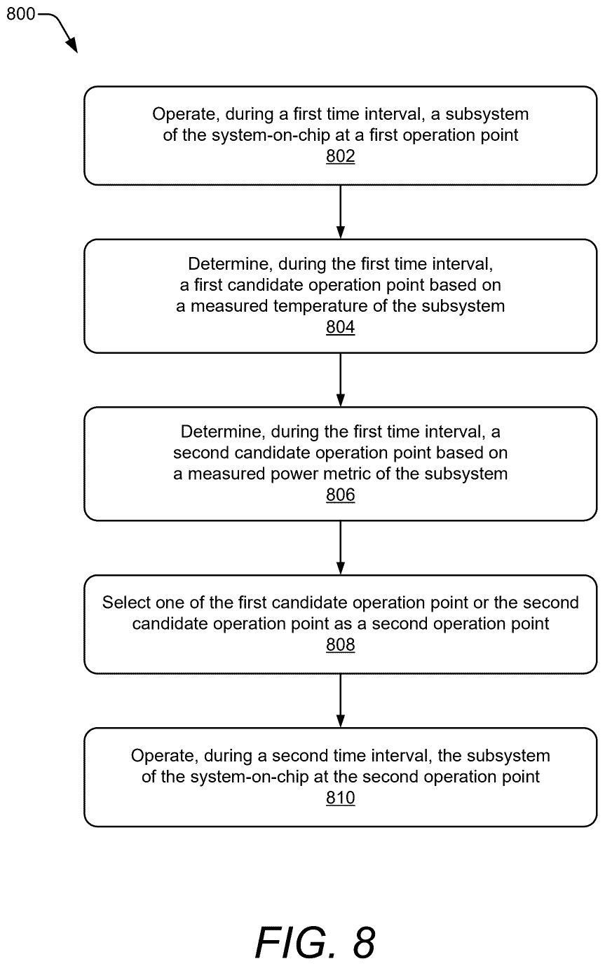

FIGS. 7 and 8 depict example methods 700 and 800 for implementing aspects of multifaceted thermal-response shaping 114. Methods 700 and 800 are shown as a set of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100 of FIG. 1, and entities detailed in FIGS. 1, 2, and 5, reference to which is made for example only. The techniques are not limited to performance by one entity or multiple entities operating on one device.

At 702 in FIG. 7, a subsystem of a system-on-chip operates at a first operation point during a first time interval. For example, the subsystem 108 operates at a first operation point 402 during a first time interval. The subsystem 108 represents a heat source 110 and generates heat 304 while operating at the first operation point 402.

At 704, a second operation point is determined during the first time interval based on a first feedback metric of multiple feedback metrics associated with the subsystem. For example, the thermal control system 112 determines a second operation point 402 based on a first feedback metric 314-1 of the subsystem 108. More specifically, the controller 514-1 determines the second operation point 402 based on a comparison of the first feedback metric 314-1 (or a modified version thereof) to a threshold provided by the thermal response shaper 502. The first feedback metric 314-1 can represent a measured temperature 316, as shown in FIG. 6. The determination of the second operation point 402 can be based on an instantaneous version of the first feedback metric 314-1 or based on an averaged (or filtered) version of the first feedback metric 314-1.

The second operation point 402 differs from the first operation point 402 by at least one heat-correlated parameter 322. For example, the second operation point 402 can specify a different clock frequency 324, a different supply voltage 326, a different brightness 328, or a different volume 330 than the first operation point 402.

At 706, the subsystem of the system-on-chip operates at the second operation point during a second time interval. For example, the subsystem 108 operates at the second operation point 402 during the second time interval. The subsystem 108 generates heat 304 while operating at the second operation point 402. The amount of heat 304 generated during the second time interval can differ from the amount of heat 304 generated during the first time interval due to the difference in the first and second operation points 402.

At 708, a third operation point is determined, during the second time interval, based on a second feedback metric of the multiple feedback metrics associated with the subsystem. The second feedback metric is different from the first feedback metric. For example, the thermal control system 112 determines a third operation point 402 based on a second feedback metric 314-2. More specifically, the controller 514-2 determines the third operation point 402 based on a comparison of the second feedback metric 314-2 (or a modified version thereof) to a threshold provided by the thermal response shaper 502. The second feedback metric 314-2 can represent a measured power metric 318, as shown in FIG. 6. The determination of the third operation point 402 can be based on an instantaneous version of the second feedback metric 314-2 or based on an average (or filtered) version of the second feedback metric 314-2.

The third operation point 402 differs from the second operation point 402 by at least one heat-correlated parameter 322. For example, the third operation point 402 can specify a different clock frequency 324, a different supply voltage 326, a different brightness 328, or a different volume 330 than the second operation point 402.

At 710, the subsystem of the system-on-chip operates at the third operation point during a third time interval. For example, the subsystem 108 operates at the third operation point 402 during the third time interval. The subsystem 108 generates heat 304 while operating at the third operation point 402. The amount of heat 304 generated during the third time interval can differ from the amount of heat 304 generated during the second time interval due to the difference in the second and third operation points 402.

At 802 in FIG. 8, a subsystem of a system-on-chip operates at a first operation point during first time interval. For example, the subsystem 108 represents a heat source 110 and generates heat 304 while operating at the first operation point 402. The subsystem 108 represents a heat source 110 and generates heat 304 while operating at the first operation point 402.

At 804, a first candidate operation point is determined during the first time interval based on a measured temperature of the subsystem. For example, the controller 514-1 determines the first candidate operation point 606-1 based on the measured temperature 316. The determination of the first candidate operation point 606-1 can be based on a comparison of the measured temperature 316 (or the modified feedback metric 604-1) to a threshold generated by the thermal response shaper 502. An operation of the controller 514-1 can be further controlled by the thermal response shaper 502 based on a specified cadence and/or based on an occurrence of a trigger, which represent different example control parameters 602.

At 806, a second candidate operation point is determined during the first time interval based on a measured power metric of the subsystem. For example, the controller 514-2 determines the second candidate operation point 606-2 based on the measured power metric 318. The determination of the second candidate operation point 606-2 can be based on a comparison of the measured power metric 318 (or the modified feedback metric 604-2) to a threshold generated by the thermal response shaper 502. An operation of the controller 514-2 can be further controlled by the thermal response shaper 502 based on a specified cadence and/or based on an occurrence of a trigger, which represent different example control parameters 602.

At 808, one of the first candidate operation point or the second candidate operation point is selected as a second operation point. For example, the resolver 506 selects one of the first candidate operation point 606-1 or the second candidate operation point 606-2 as the second operation point 402, as shown in FIG. 6. The resolver 506 can use a comparator and/or a machine-learned model to make the selection.

At 810, the subsystem of the system-on-chip operates at the second operation point during a second time interval. For example, the subsystem 108 operates at the second operation point 402 during the second time interval. The subsystem 108 generates heat 304 while operating at the second operation point 402. The amount of heat 304 generated during the second time interval can differ from the amount of heat 304 generated during the first time interval due to the difference in the first and second operation points 402.

In the examples described with respect to FIGS. 7 and 8, different operation points are determined based on evaluations of two or more different feedback metrics 314. Other implementations of multifaceted thermal-response shaping 114 are also possible in that different operation points 402 are determined based on evaluations of a same feedback metric 314 over two or more different time scales 510. Still other implementations of multifaceted thermal-response shaping 114 are also possible in that different operation points 402 are determined based on evaluations of two or more different feedback metrics 314 over two or more different time scales 510.

### Example Computing System

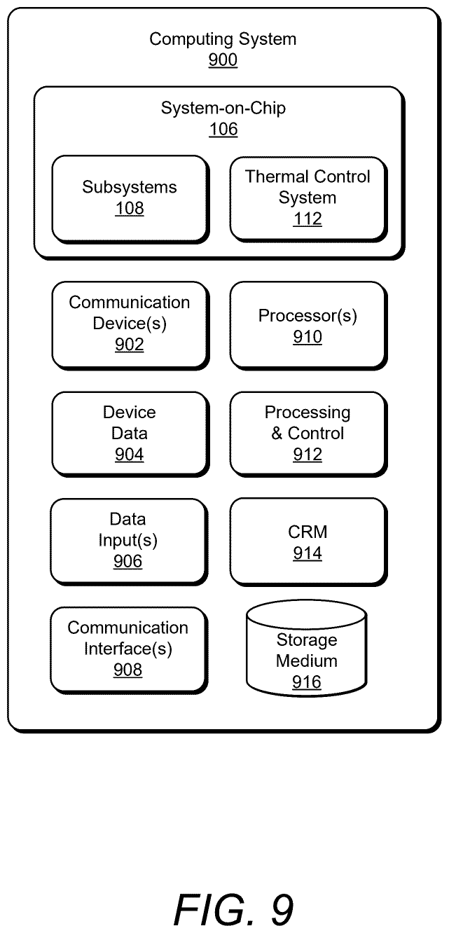

FIG. 9 illustrates various components of an example computing system 900 that can be implemented as any type of client, server, and/or computing device as described with reference to the previous FIGS. 2 and 3 to implement aspects of multifaceted thermal-response shaping 114 for a subsystem.

The computing system 900 includes communication devices 902 that enable wired and/or wireless communication of device data 904 (e.g., received data, data that is being received, data scheduled for broadcast, or data packets of the data). The device data 904 or other device content can include configuration settings of the device, media content stored on the device, and/or information associated with a user of the device. Media content stored on the computing system 900 can include any type of audio, video, and/or image data. The computing system 900 includes one or more data inputs 906 via which any type of data, media content, and/or inputs can be received.

The computing system 900 also includes communication interfaces 908, which can be implemented as any one or more of a serial and/or parallel interface, a wireless interface, any type of network interface, a modem, and as any other type of communication interface. The communication interfaces 908 provide a connection and/or communication links between the computing system 900 and a communication network by which other electronic, computing, and communication devices communicate data with the computing system 900.

The computing system 900 includes one or more processors 910 (e.g., any of microprocessors, controllers, and the like), which process various computer-executable instructions to control the operation of the computing system 900. Alternatively or in addition, the computing system 900 can be implemented with any one or combination of hardware, firmware, or fixed logic circuitry that is implemented in connection with processing and control circuits which are generally identified at 912. Although not shown, the computing system 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 900 also includes a computer-readable medium 914 (CRM 914), such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 900 can also include a mass storage medium device (storage medium) 916.

The computer-readable medium 914 provides data storage mechanisms to store the device data 904, as well as various device applications and any other types of information and/or data related to operational aspects of the computing system 900. For example, an operating system can be maintained as a computer application with the computer-readable medium 914 and executed on the processors 910. The device applications may include a device manager, such as any form of a control application, software application, signal-processing and control module, code that is native to a particular device, a hardware abstraction layer for a particular device, and so on.

The computing system 900 also includes at least one system-on-chip 106. The system-on-chip 106 includes one or more subsystems 108 and at least one thermal control system 112. In some implementations, the processor 910, the processing and control 912, the computer-readable medium 914, and/or the storage medium 916 can represent one or more subsystems 108 of a system-on-chip 106. The thermal control system 112 is capable of performing aspects of multifaceted thermal-response shaping 114.

### Conclusion

Although techniques using, and apparatuses including, multifaceted thermal-response shaping have been described in language specific to features and/or methods, it is to be understood that the subject of the appended claims is not necessarily limited to the specific features or methods described. Rather, the specific features and methods are disclosed as example implementations of multifaceted thermal-response shaping.

Some Examples are described below.

Example 1: A method performed by a system-on-chip, the method comprising:
operating, during a first time interval, a subsystem of the system-on-chip at a first operation point;
determining, during the first time interval, a second operation point based on a first feedback metric of multiple feedback metrics associated with the subsystem;
operating, during a second time interval, the subsystem of the system-on-chip at the second operation point;
determining a third operation point based on a second feedback metric of the multiple feedback metrics associated with the subsystem, the second feedback metric being different from the first feedback metric; and
operating, during a third time interval, the subsystem of the system-on-chip at the third operation point.

Example 2: The method of example 1, wherein:
the operating of the subsystem at the first operation point causes the subsystem to generate a first amount of heat;
the operating of the subsystem at the second operation point causes the subsystem to generate a second amount of heat that differs from the first amount of heat; and
the operating of the subsystem at the third operation point causes the subsystem to generate a third amount of heat that differs from the first amount of heat and the second amount of heat.

Example 3: The method of example 1 or 2, wherein values of the multiple feedback metrics are dependent on a current workload associated with the subsystem.

Example 4: The method of example 3, wherein the multiple feedback metrics comprise:
a measured temperature associated with the subsystem; and
a measured power metric associated with the subsystem.

Example 5: The method of example 4, wherein:
the determining of the second operation point based on the first feedback metric comprises determining the second operation point based on an instantaneous value of the measured temperature or based on an average value of the measured temperature over a first time window; and
the determining of the third operation point based on the second feedback metric comprises determining the third operation point based on an instantaneous value of the measured power metric or based on an average value of the measured power metric over a second time window.

Example 6: The method of example 5, wherein:
the determining of the second operation point based on the first feedback metric comprises determining the second operation point based on an instantaneous value of the measured temperature; and
the method further comprises:
   determining, during the third time interval, a fourth operation point based on the average value of the measured temperature over the first time window; and
   operating, during a fourth time interval, the subsystem of the system-on-chip at the fourth operation point.

Example 7: The method of example 6, further comprising:
determining, during the fourth time interval, a fifth operation point based on the average value of the measured temperature over a third time window, the third time window being different from the first time window; and
operating, during a fifth time interval, the subsystem of the system-on-chip at the fifth operation point.

Example 8: A method performed by a system-on-chip, the method comprising:
operating, during a first time interval, a subsystem of the system-on-chip at a first operation point;
determining, during the first time interval, a first candidate operation point based on a measured temperature of the subsystem;
determining, during the first time interval, a second candidate operation point based on a measured power metric of the subsystem;
selecting one of the first candidate operation point or the second candidate operation point as a second operation point; and
operating, during a second time interval, the subsystem of the system-on-chip at the second operation point.

Example 9: The method of example 8, wherein the selecting of one of the first candidate operation point or the second candidate operation point comprises selecting the one of the first candidate operation point or the second candidate operation point that is associated with a smaller amount of heat generation.

Example 10: The method of example 8 or 9, wherein the selecting of one of the first candidate operation point or the second candidate operation point comprises selecting the one of the first candidate operation point or the second candidate operation point that is associated with a higher level of performance.

Example 11: The method of any one of examples 8 to 10, further comprising:
determining, during the first time interval, a first time scale based at least on the measured temperature;
generating, during the first time interval, a first modified metric by filtering the measured temperature based on the first time scale;
determining, during the first time interval, a second time scale based at least on the measured power metric; and
generating, during the first time interval, a second modified metric by filtering the measured power metric based on the second time scale, wherein:
the determining of the first candidate operation point comprises determining the first candidate operation point based on the first modified metric; and
the determining of the second candidate operation point comprises determining the second candidate operation point based on the second modified metric.

Example 12: The method of example 11, further comprising:
generating, during the first time interval, control parameters based on the measured temperature and based on the measured power metric, wherein:
the determining of the first candidate operation point comprises determining the first candidate operation point based on the first modified metric and based on a first set of the control parameters; and
the determining of the second candidate operation point comprises determining the second candidate operation point based on the second modified metric and based on a second set of the control parameters.

Example 13: The method of example 12, wherein:
the control parameters comprise:
   a first threshold associated with the first modified metric; and
   a second threshold associated with the second modified metric;
the determining of the first candidate operation point comprises determining the first candidate operation point based on a comparison between the first threshold and the first modified metric; and
the determining of the second candidate operation point comprises determining the second candidate operation point based on a comparison between the second threshold and the second modified metric.

Example 14: The method of example 13, wherein:
the control parameters comprise a first cadence and a second cadence; and
the determining of the first candidate operation point comprises determining the first candidate operation point at a time that corresponds with the first cadence; and
the determining of the second candidate operation point comprises determining the second candidate operation point at a time that correspond with the second cadence.

Example 15: The method of example 13, wherein:
the control parameters comprise a first trigger and a second trigger; and
the determining of the first candidate operation point comprises determining the first candidate operation point based on an occurrence of the first trigger; and
the determining of the second candidate operation point comprises determining the second candidate operation point based on an occurrence of the second trigger.

Example 16: The method of any one of examples 8 to 15, further comprising:
determining, during the second time interval, a third candidate operation point based on the measured temperature of the subsystem;
determining, during the second time interval, a fourth candidate operation point based on the measured power metric of the subsystem;
selecting one of the third candidate operation point or the fourth candidate operation point as a third operation point; and
operating, during a third time interval, the subsystem of the system-on-chip at the third operation point.

Example 17: A system-on-chip comprising:
at least one subsystem configured to:
   operate at a first operation point during a first time interval; and
   operate at a second operation point during a second time interval; and
at least one thermal control system coupled to the at least one subsystem and configured to:
   determine, during the first time interval, a first candidate operation point based on a measured temperature of the subsystem;
   determine, during the first time interval, a second candidate operation point based on a measured power metric of the subsystem;
   select one of the first candidate operation point or the second candidate operation point as the second operation point; and
   cause the at least one subsystem to operate at the second operation point during the second time interval.

Example 18: The system-on-chip of example 17, wherein:
the second operation point is associated with at least one heat-correlated parameter that differs in value from a similar heat-correlated parameter associated with the first operation point; and
the at least one heat-correlated parameter comprises at least one of the following:
   a clock frequency;
   a supply voltage;
   a brightness;
   a volume; or
   a transmit power level.

Example 19: The system-on-chip of example 17 or 18, wherein:
the at least one subsystem is configured to operate at a third operation point during a third time interval; and
the at least one thermal control system is configured to:
   determine, during the second time interval, a third candidate operation point based on the measured temperature of the subsystem;
   determine, during the second time interval, a fourth candidate operation point based on the measured power metric of the subsystem;
   select one of the third candidate operation point or the fourth candidate operation point as a third operation point; and
   cause the at least one subsystem to operate at the third operation point during the third time interval.

Example 20: The system-on-chip of example 19, wherein the at least one thermal control system is further configured to:
determine, during the first time interval, a first time scale based at least one the measured temperature;
generate, during the first time interval, a first modified metric by filtering the measured temperature based on the first time scale;
determine, during the second time interval, a second time scale based at least one the measured temperature;
generate, during the second time interval, a second modified metric by filtering the measured temperature based on the second time scale;
determine, during the first time interval, the first candidate operation point based on the first modified metric; and
determine, during the second time interval, the third candidate operation point based on the second modified metric.

What is claimed is:

1. A method performed by a system-on-chip, the method comprising:
operating, during a first time interval, a subsystem of the system-on-chip at a first operation point;
determining, during the first time interval, a second operation point based on a first feedback metric of multiple feedback metrics associated with the subsystem;
operating, during a second time interval, the subsystem of the system-on-chip at the second operation point;
determining a third operation point based on a second feedback metric of the multiple feedback metrics associated with the subsystem, the second feedback metric being different from the first feedback metric; and
operating, during a third time interval, the subsystem of the system-on-chip at the third operation point.

2. The method of claim 1, wherein:
the operating of the subsystem at the first operation point causes the subsystem to generate a first amount of heat;
the operating of the subsystem at the second operation point causes the subsystem to generate a second amount of heat that differs from the first amount of heat; and
the operating of the subsystem at the third operation point causes the subsystem to generate a third amount of heat that differs from the first amount of heat and the second amount of heat.

3. The method of claim 1, wherein values of the multiple feedback metrics are dependent on a current workload associated with the subsystem.

4. The method of claim 3, wherein the multiple feedback metrics comprise:
a measured temperature associated with the subsystem; and
a measured power metric associated with the subsystem.

5. The method of claim 4, wherein:
the determining of the second operation point based on the first feedback metric comprises determining the second operation point based on an instantaneous value of the measured temperature or based on an average value of the measured temperature over a first time window; and
the determining of the third operation point based on the second feedback metric comprises determining the third operation point based on an instantaneous value of the measured power metric or based on an average value of the measured power metric over a second time window.

6. The method of claim 5, wherein:
the determining of the second operation point based on the first feedback metric comprises determining the second operation point based on an instantaneous value of the measured temperature; and
the method further comprises:
determining, during the third time interval, a fourth operation point based on the average value of the measured temperature over the first time window; and
operating, during a fourth time interval, the subsystem of the system-on-chip at the fourth operation point.

7. The method of claim 6, further comprising:
determining, during the fourth time interval, a fifth operation point based on the average value of the measured temperature over a third time window, the third time window being different from the first time window; and
operating, during a fifth time interval, the subsystem of the system-on-chip at the fifth operation point.

8. A method performed by a system-on-chip, the method comprising:
operating, during a first time interval, a subsystem of the system-on-chip at a first operation point;
determining, during the first time interval, a first candidate operation point based on a measured temperature of the subsystem;
determining, during the first time interval, a second candidate operation point based on a measured power metric of the subsystem;
selecting one of the first candidate operation point or the second candidate operation point as a second operation point; and
operating, during a second time interval, the subsystem of the system-on-chip at the second operation point.

9. The method of claim 8, wherein the selecting of one of the first candidate operation point or the second candidate operation point comprises selecting the one of the first candidate operation point or the second candidate operation point that is associated with a smaller amount of heat generation.

10. The method of claim 8, wherein the selecting of one of the first candidate operation point or the second candidate operation point comprises selecting the one of the first candidate operation point or the second candidate operation point that is associated with a higher level of performance.

11. The method of claim 8, further comprising:
determining, during the first time interval, a first time scale based at least on the measured temperature;
generating, during the first time interval, a first modified metric by filtering the measured temperature based on the first time scale;
determining, during the first time interval, a second time scale based at least on the measured power metric; and
generating, during the first time interval, a second modified metric by filtering the measured power metric based on the second time scale, wherein:
the determining of the first candidate operation point comprises determining the first candidate operation point based on the first modified metric; and
the determining of the second candidate operation point comprises determining the second candidate operation point based on the second modified metric.

12. The method of claim 11, further comprising:
generating, during the first time interval, control parameters based on the measured temperature and based on the measured power metric, wherein:
the determining of the first candidate operation point comprises determining the first candidate operation point based on the first modified metric and based on a first set of the control parameters; and
the determining of the second candidate operation point comprises determining the second candidate operation point based on the second modified metric and based on a second set of the control parameters.

13. The method of claim 12, wherein:
the control parameters comprise:
a first threshold associated with the first modified metric; and
a second threshold associated with the second modified metric;
the determining of the first candidate operation point comprises determining the first candidate operation point based on a comparison between the first threshold and the first modified metric; and
the determining of the second candidate operation point comprises determining the second candidate operation point based on a comparison between the second threshold and the second modified metric.

14. The method of claim 13, wherein:
the control parameters comprise a first cadence and a second cadence; and
the determining of the first candidate operation point comprises determining the first candidate operation point at a time that corresponds with the first cadence; and
the determining of the second candidate operation point comprises determining the second candidate operation point at a time that correspond with the second cadence.

15. The method of claim 13, wherein:
the control parameters comprise a first trigger and a second trigger; and
the determining of the first candidate operation point comprises determining the first candidate operation point based on an occurrence of the first trigger; and
the determining of the second candidate operation point comprises determining the second candidate operation point based on an occurrence of the second trigger.

16. The method of claim 8, further comprising:
determining, during the second time interval, a third candidate operation point based on the measured temperature of the subsystem;
determining, during the second time interval, a fourth candidate operation point based on the measured power metric of the subsystem;
selecting one of the third candidate operation point or the fourth candidate operation point as a third operation point; and
operating, during a third time interval, the subsystem of the system-on-chip at the third operation point.

17. A system-on-chip comprising:
at least one subsystem configured to:
operate at a first operation point during a first time interval; and
operate at a second operation point during a second time interval; and
at least one thermal control system coupled to the at least one subsystem and configured to:
determine, during the first time interval, a first candidate operation point based on a measured temperature of the subsystem;
determine, during the first time interval, a second candidate operation point based on a measured power metric of the subsystem;
select one of the first candidate operation point or the second candidate operation point as the second operation point; and
cause the at least one subsystem to operate at the second operation point during the second time interval.

18. The system-on-chip of claim 17, wherein:
the second operation point is associated with at least one heat-correlated parameter that differs in value from a similar heat-correlated parameter associated with the first operation point; and
the at least one heat-correlated parameter comprises at least one of the following:
a clock frequency;
a supply voltage;
a brightness;
a volume; or
a transmit power level.

19. The system-on-chip of claim 17, wherein:
the at least one subsystem is configured to operate at a third operation point during a third time interval; and
the at least one thermal control system is configured to:
determine, during the second time interval, a third candidate operation point based on the measured temperature of the subsystem;
determine, during the second time interval, a fourth candidate operation point based on the measured power metric of the subsystem;
select one of the third candidate operation point or the fourth candidate operation point as a third operation point; and
cause the at least one subsystem to operate at the third operation point during the third time interval.

20. The system-on-chip of claim 19, wherein the at least one thermal control system is further configured to:
determine, during the first time interval, a first time scale based at least one the measured temperature;
generate, during the first time interval, a first modified metric by filtering the measured temperature based on the first time scale;
determine, during the second time interval, a second time scale based at least one the measured temperature;
generate, during the second time interval, a second modified metric by filtering the measured temperature based on the second time scale;
determine, during the first time interval, the first candidate operation point based on the first modified metric; and
determine, during the second time interval, the third candidate operation point based on the second modified metric.
